(19) United States
(12) Patent Application Publication
(10) Pub. No.: US 2010/0265388 A1
(43) Pub. Date: Oct. 21, 2010

(54) LID OPENING AND CLOSING MECHANISM

(76) Inventor: Mitsuo Soumi, Kurokawa-gun (JP)

Correspondence Address: SUGHRUE MION, PLLC, 2100 PENNSYLVANIA AVENUE, N.W., SUITE 800, WASHINGTON, DC, 20037, US

(21) Appl. No.: 12/096,280

(22) PCT Filed: Dec. 4, 2006
(86) PCT No.: PCT/JP2006/324605

§ 371 Date: Feb. 2, 2010

(30) Foreign Application Priority Data
Dec. 15, 2005 (JP) 2005-362230

(51) Int. Cl. H04N 5/225; G03B 17/02; H04W 88/02; B65D 45/00

(52) U.S. Cl. 348/374; 396/539; 455/575.1; 220/315; 348/E05.026

(57) ABSTRACT

A container unit (27) of an electronic camera is composed of a loading lid (35) and a slot forming surface (32) in which slots (33a, 33b) are formed. The loading lid is rotatably and slidably attached to a shaft support member (39), which is disposed on the slot forming surface, via a lid attachment shaft (38). The loading lid is provided with a claw (40). A torsion spring (42) is secured to the lid attachment shaft. The slot forming surface is provided with a frame (41) and a block-shaped protrusion (43). The torsion spring engages with the protrusion to click and lock the loading lid at a lock position where the claw engages with the frame. Upon sliding the loading lid to a lock release position where the claw is disengaged from the frame, the loading lid is automatically rotated to an open position owing to the torsion spring.

### TECHNICAL FIELD

The present invention relates to an opening and closing mechanism for a lid rotatably and slidably supported by a case.

### BACKGROUND ART

In a small-sized electronics device of an electronic camera and so force provided for the purpose of outdoor usage, a battery pack is normally used as a power source. For this reason, a battery chamber for loading the battery pack is formed inside a body of the electronics device. The battery pack is inserted into the battery chamber through a battery insertion opening formed in an outer surface of the body. The battery insertion opening is opened and closed by a loading lid rotatably attached to the body. In order to prevent the loading lid from being mistakenly opened, the loading lid is usually locked in a closed position where the battery insertion opening is covered. Lock of the loading lid is released at a time of inserting and removing the battery and the loading lid is rotated to an open position where the battery insertion opening is opened.

Recently, in a popularized electronics device, a spring piece is attached to the rear of the loading lid so that the battery is easily inserted and removed (see Japanese Patent Laid-Open Publication No. 10-92403). The spring piece is formed in a shape that the spring piece comes into contact with an edge of the battery insertion opening when the loading lid is kept in a half-open position. Consequently, in the state that the spring piece abuts on the edge of the battery insertion opening, the spring piece is elastically deformed when the loading lid is rotated to the closed position. Then the loading lid is locked in the closed position and the spring piece is kept in the elastically deformed state. Upon releasing the lock of the loading lid, the lid is automatically rotated to the half-open position by elastic restoring force of the spring piece. From this state, the loading lid is further rotated to the open position to unclose the battery insertion opening. Thus, it is unnecessary to rotate the loading lid by engaging a claw therewith such as a conventional way so that the battery is easily inserted and removed.

In this way, the electronics device described in the above-noted Publication No. 10-92403 can automatically open the loading lid to the half-open position after releasing the lock. However, in order to perfectly open the battery insertion opening, a user needs to manually open the loading lid to the open position. In this regard, a mechanism for biasing the loading lid to the open position may be provided instead of the spring piece. However, a number of parts for composing the electronics device increases. As a result, assembling processes increase and production cost rises.

It is an object of the present invention to provide a lid opening and closing mechanism in which it is possible to rotate a lid of a loading lid and so forth to an open position after releasing lock of the lid without increasing a number of parts and assembling processes.

### DISCLOSURE OF INVENTION

In order to achieve the above objects and other objects, the lid opening and closing mechanism according to the present invention comprises a spring member and a click-lock member. The lid is rotatably and slidably supported by a case. The lid is slid from a lock position, where the lid covers a part of the case and is locked therewith, to a lock release position, where the lid is unlocked from the case. Via the lock release position, the lid is rotated to an open position where the part of the case is exposed. The lid moved to the lock release position is biased toward the open position by the spring member. When the lid is kept in the lock position, the spring member elastically engages with the click-lock member to give a resistance to the slide operation of the lid. Upon performing the slide operation overcoming the resistance, the elastic engagement of the spring member and the click-lock member is released so that the lid is moved to the lock release position.

In a preferred embodiment, a shaft of the lid is slidably supported by the case, and the spring member is a torsion spring supported by inserting the shaft into a coil portion thereof. One end of the torsion spring is linked to the lid and an arm portion thereof is pressed against the part of the case. The click-lock member is a block-shaped protrusion disposed at the part of the case. When the lid is slid from the lock position to the lock release position, the arm portion of the torsion spring elastically engages with the block-shaped protrusion to give the resistance to the slide operation of the lid. Upon performing the slide operation overcoming the resistance, the engagement of the block-shaped protrusion and the arm portion is released so that the lid is moved to the lock release position.

The block-shaped protrusion has a first contact surface, a second contact surface and a third contact surface. When the lid is kept in the lock position, the arm portion of the torsion spring abuts on the first contact surface. When the lid is kept in the lock release position, the arm portion abuts on the second contact surface. The third contact surface connects the first and second contact surfaces. It is preferable that the first and second contact surfaces slope so as to reduce an interval thereof in a height direction. In addition, it is preferable that a click feeling and a click sound are caused in accordance with a height and an incline angle of the respective first and second contact surfaces when the lid is slid from one of the lock position and the lock release position to the other thereof.

It is preferable that the torsion spring has a double torsion-spring structure in which a pair of the coil portions is connected via the arm portion bent or curved in a convex shape. Moreover, it is preferable that the arm portion has a concave portion formed by bending the middle thereof. The concave portion abuts on the first contact surface of the block-shaped protrusion when the lid is kept in the lock position. Further, it is preferable to comprise a detector for detecting opening and closing of the lid by judging whether or not the arm portion of the torsion spring is kept in the position abutting on the first contact surface of the block-shaped protrusion.

In another embodiment, the spring member is a leaf spring, one end of which is fixed to the case and the other end of which slidably supports the lid. The other end of the leaf spring has an engagement claw for engaging with the lid. When the lid is kept in the lock position and the lock release position, the one end and the other end of the leaf spring are bent and charged. The click-lock member is a hollow formed in the lid. When the lid is kept in the lock position, the engagement claw elastically engages with the hollow to give a resistance to the slide operation of the lid. Upon performing the slide operation overcoming the resistance, the engagement of the hollow and the engagement claw is released so that the lid is moved to the lock release position.

A slot, which connects to a container chamber disposed inside the case, is formed in the part of the case. When the lid is kept in the lock position and the lock release position, the slot is closed by the lid. When the lid is kept in the open position, the slot is exposed.

According to the present invention, the spring member is also used for clicking and locking the lid kept in the lock position. As a result, it is possible to rotate the lid to the open position after the lock release without increasing a number of components and assembling processes. Thus, an operation of a user for rotating the lid to the open position becomes unnecessary. Further, it is possible to hold down production cost of various devices, machines and mechanisms including a lid which is rotatably and slidably supported by a case.

### BRIEF DESCRIPTION OF DRAWINGS

FIG. 1 is a front perspective view of an electronic camera;

FIG. 2 is a rear perspective view of the electronic camera;

FIG. 3 is a perspective view of a container unit in which a loading lid is kept in an open position;

FIG. 4 is a perspective view of the container unit in which the loading lid is kept in a lock position;

FIG. 5 is a perspective view of a torsion spring;

FIG. 6 is a section view of the container unit taken along a VI-VI line shown in FIG. 4;

FIG. 7 is a section view of the container unit shown in FIG. 4;

FIG. 8 is a section view of a block-shaped protrusion;

FIG. 9 is a section view of the block-shaped protrusion of another embodiment in that a click feeling and a click sound are restrained;

FIG. 10 is a perspective view of the torsion spring of the other embodiment in that lock strength is adjustable in a small space;

FIG. 11 is a perspective view of the container unit of the other embodiment in that the loading lid is attached to a case via a leaf spring and is kept in the open position;

FIG. 12 is a perspective view of the container unit of the other embodiment in that the loading lid is attached to the case via the leaf spring and is kept in the lock position;

FIG. 13 is a section view of the container unit taken along a XIII-XIII line shown in FIG. 11;

FIG. 14 is a section view of the container unit taken along a XIV-XIV line shown in FIG. 12;

FIG. 15 is a section view of the container unit which is shown in FIG. 12 and in which the loading lid is kept in the lock release position;

FIG. 16 is a perspective view of a foldable cell-phone in which an earpiece unit is kept in an open position; and

FIG. 17 is a perspective view of the foldable cell-phone in which the earpiece unit is kept in a lock position.

### BEST MODE FOR CARRYING OUT THE INVENTION

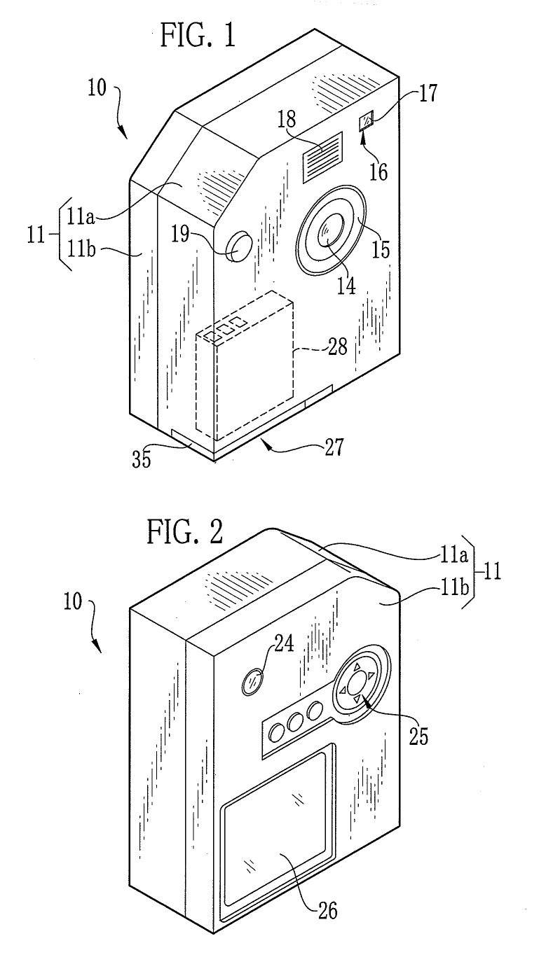

FIG. 1 is a front perspective view showing an electronic camera 10 regarded as an electronics device of the present invention. FIG. 2 is a rear perspective view of the electronic camera 10. A case 11 of the electronic camera 10 is composed of a front cover 11a and a rear cover 11b. The front of the case 11 is provided with a lens barrel 15, an object-side viewfinder window 17, a flash emitter 18 and a shutter button 19. The lens barrel 15 contains a taking lens 14. The object-side viewfinder window 17 constitutes a viewfinder 16. The flash emitter 18 emits a flashlight toward a subject. The shutter button 19 is used for a shutter release operation. The lens barrel 15 is retracted in the case 11 when a power supply of the electronic camera 10 is turned off. Upon turning on the power supply, the lens barrel 15 projects from the front of the case 11.

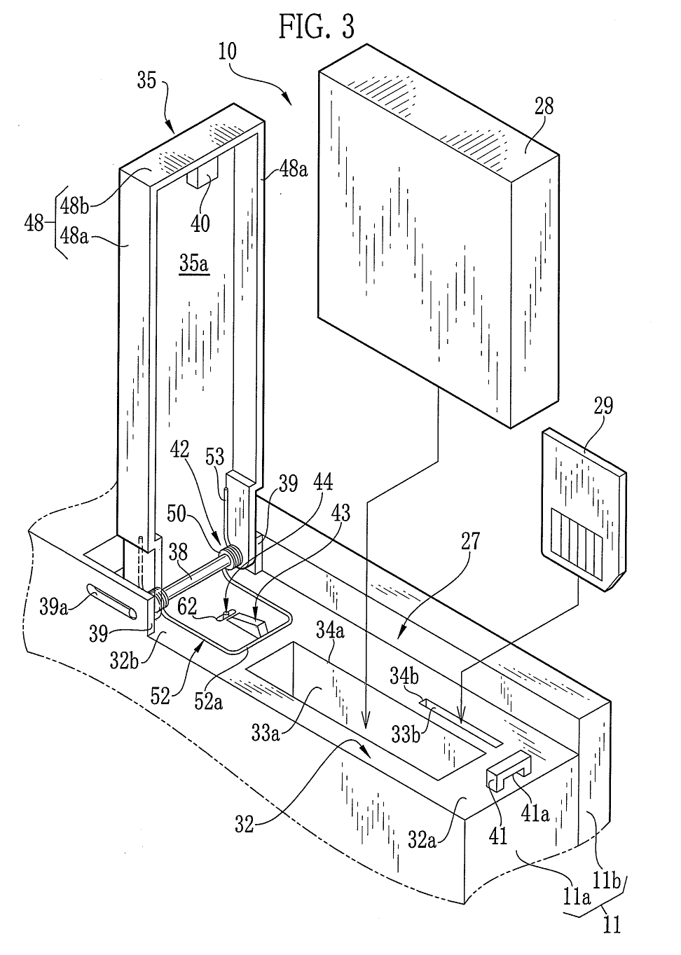

The rear of the case 11 is provided with an eye-side viewfinder window 24, an operating portion 25 and an LCD 26. The eye-side viewfinder window 24 constitutes the viewfinder 16. The operating portion 25 is composed of plural buttons. The LCD 26 works as an electronic viewfinder and displays an image. Meanwhile, a container unit 27 is set in the case 11 besides a camera body (not shown) in which various imaging mechanisms are incorporated. The container unit 27 is loaded with a battery pack 28 and a memory card 29 (see FIG. 3) . The battery pack 28 supplies electric power to each part of the electronic camera 10. The memory card 29 stores image data.

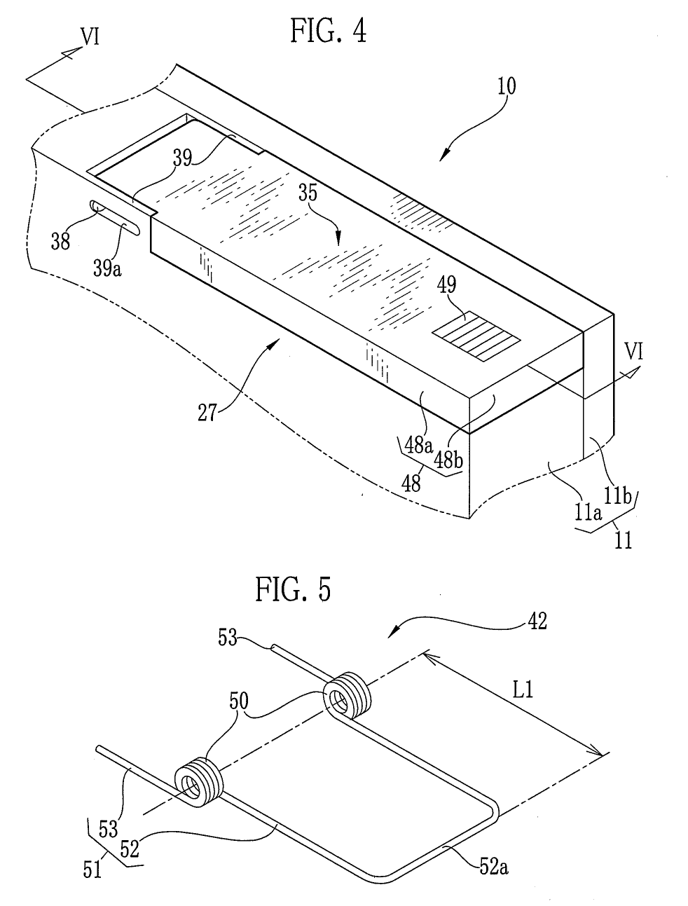

FIGS. 3 and 4 are perspective views of the container unit 27 viewed from a bottom side of the case 11. The container unit 27 is composed of a slot forming surface 32, a battery chamber 33a, a card chamber 33b, a battery slot 34a, a card slot 34b and a loading lid 35. Further, the container unit 27 comprises a lid attachment shaft 38, shaft support members 39, an engagement claw 40, an engagement frame 41, a torsion spring 42, a block-shaped protrusion 43 and a detection switch 44, which constitute a lock device of the present invention.

The slot forming surface 32 is formed by cutting a bottom corner portion of the case 11 in a rectangular shape. In the following description, a case-side end portion of the slot forming surface 32 is defined as a first end portion 32a, and an opposite end portion thereof is defined as a second end portion 32b. Between the first and second end portions 32a and 32b of the slot forming surface 32, the battery slot 34a connecting to the battery chamber 33a and the card slot 34b connecting to the card chamber 33b are formed. The battery pack 28 is loaded into the battery chamber 33a through the battery slot 34a. The memory card 29 is loaded into the card chamber 33b through the card slot 34b. Both the slots 34a and 34b are opened and closed by the loading lid 35.

The loading lid 35 is attached to the case 11 via the lid attachment shaft 38. A side wall 48 is formed on an inner surface 35a of the loading lid 35 confronting the slot forming surface 32. The side wall 48 is composed of first wall members 48a and a second wall member 48b. The first wall members 48a are formed along both lateral edges of the loading lid 35. The second wall member 48b is formed along a case-side edge of the loading lid 35. An attachment hole (not shown) for attaching the lid attachment shaft 38 is formed in the respective first wall members 48a. Meanwhile, the engagement claw 40 described later in detail is formed on an inner surface of the second wall member 48b.

The lid attachment shaft 38 is formed so as to be longer than a breadth of the loading lid 35. The lid attachment shaft 38 is rotatably and slidably supported by the pair of the shaft support members 39 integrally formed with the case 11.

The shaft support members 39 are formed on the second end portion 32b of the slot forming surface 32. Both the shaft support members 39 have an elongate hole 39a extending in a longitudinal direction (hereinafter referred to as slide direction) of the slot forming surface 32. Both ends of the lid attachment shaft 38 respectively engage with the elongate holes 39a. In virtue of this, the lid attachment shaft 38 is rotatably supported by the shaft support members 39, and at the same time, is slidably supported thereby in the slide direction.

The loading lid 35 is usually locked so as not to be mistakenly opened. The loading lid 35 is locked by the engagement claw 40 and the engagement frame 41 engaging therewith. As described above, the engagement claw 40 is formed on the inner surface of the second wall member 48b of the loading lid 35. The engagement frame 41 is formed on the first end portion 32a of the slot forming surface 32. The engagement frame 41 has an engagement hole 41a extending in the slide direction and formed at a position where the engagement claw 40 of the loading lid 35 engages therewith. It is possible to switch engagement and disengagement of the claw 40 and the frame 41 by sliding the loading lid 35.

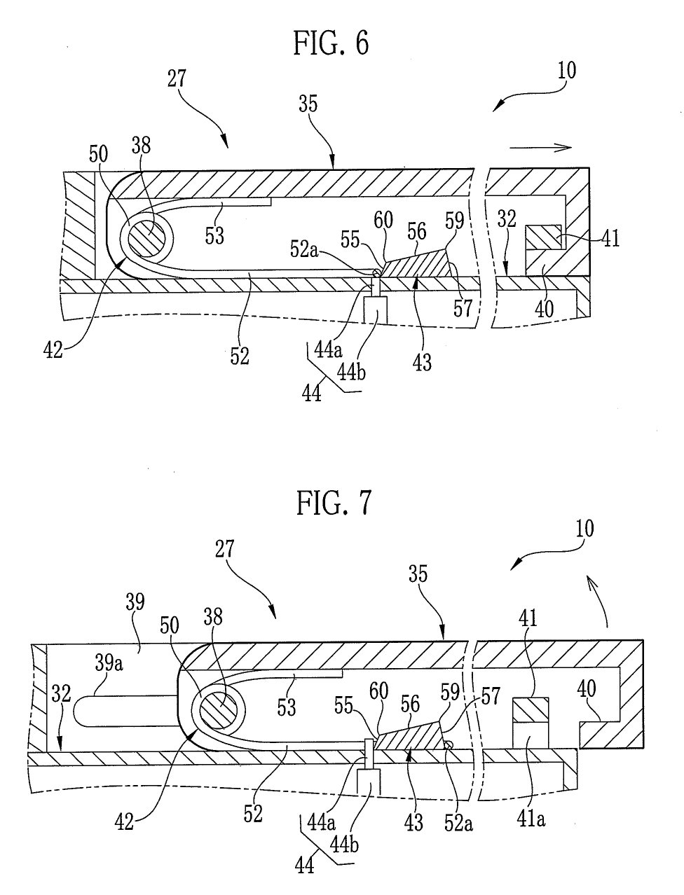

When the loading lid 35 is kept in a lock position where the loading lid 35 covers the slot forming surface 32 and is locked by the case 11 (see FIGS. 4 and 6), the engagement claw 40 engages with the engagement frame 41. In virtue of this, the loading lid 35 is locked so as not to be opened. Incidentally, in this embodiment, a slide operating portion 49 having concavity and convexity is formed on an outer surface of the loading lid 35 (see FIG. 4) so that a user can easily perform the slide operation of the loading lid 35.

Upon sliding the loading lid 35 along the slot forming surface 32 to a lock release position where the engagement claw 40 is disengaged from the engagement frame 41 (see FIG. 7), the loading lid 35 becomes rotatable. Consequently, it becomes possible to rotate the loading lid 35 to an open position where both the slots 34a and 34b are opened.

The torsion spring 42 biases the loading lid 35 toward the open position. The torsion spring 42 has a so-called double torsion-spring structure such as shown in FIGS. 3 and 5, and is composed of a pair of coil portions 50 and an arm portion 51.

Into the pair of the coil portions 50, the lid attachment shaft 38 of the loading lid 35 is inserted. The arm portion 51 is composed of a first arm 52 and second arms 53 extending from both the coil portions 50. The first arm 52 corresponds to one end of the torsion spring of the present invention. The first arm 52 is formed in a U-like shape between the coil portions 50 to connect these portions 50. The first arm 52 has a contact portion 52a, which is parallel to the lid attachment shaft 38 and is pressed against the second end portion 32b of the slot forming surface 32. In this embodiment, the second end portion 32b corresponds to a spring receiver portion of the present invention. Meanwhile, the second arms 53 correspond to the other end of the torsion spring of the present invention. The second arms 53 extend from the outsides of the coil portions 50 in the same direction and abut on the inner surface 35a of the loading lid 35. Incidentally, reference numeral L1 shown in FIG. 5 denotes a length from the center of the coil portions 50 to the contact portion 52a.

The torsion spring 42 is elastically deformed between the loading lid 35, which is kept in the lock position and the lock release position, and the slot forming surface 32 (second end portion 32b) of the case 11 (see FIG. 6). Upon sliding the loading lid 35 from the lock position to the lock release position, the torsion spring 42 biases the loading lid in an open direction by its elastic restoring force to retain the loading lid in the open position (see FIGS. 3 and 7). In other words, by merely sliding the loading lid 35 to the lock release position, it is possible to automatically rotate the loading lid 35 to the open position. In this embodiment , the loading lid 35 is clicked and locked at the lock position by using the torsion spring 42 and the block-shaped protrusion 43, which is described later, for the purpose of preventing the loading lid 35 from being mistakenly opened.

The block-shaped protrusion 43 corresponds to a click-lock member of the present invention and is disposed on the second end portion 32b of the slot forming surface 32 (see FIG. 3). The torsion spring 42 slid together with the loading lid 35 elastically engages with the block-shaped protrusion 43 to click and lock the loading lid 35 at the lock position.

As shown in FIGS. 6 to 8, the block-shaped protrusion 43 has first to third incline surfaces 55 to 57. In this embodiment, a height H1 of the third incline surface 57 is taller than a height H2 of the first incline surface 55. Consequently, a corner 59 formed by the second and third incline surfaces 56 and 57 is regarded as the top of the block-shaped protrusion 43. Incidentally, reference numeral 60 denotes a corner formed by the first and second incline surfaces 55 and 56, and reference letter W denotes a length of the block-shaped protrusion 43.

The first incline surface 55 corresponds to a first contact surface of the present invention. When the loading lid 35 is kept in the lock position, the contact portion 52a of the first arm 52 abuts on the first incline surface 55 (see FIG. 6). The second incline surface 56 constitutes an upper surface of the block-shaped protrusion 43. The third incline surface 57 corresponds to a second contact surface of the present invention. When the loading lid 35 is kept in the lock release position, the contact portion 52a of the first arm 52 abuts on the third incline surface 57 (see FIG. 7).

At this time, the position of the contact portion 52a of the first arm 52 is likely to be shifted in the slide direction due to variation of the length Li of the torsion spring (see FIG. 5), a diameter of the coil portion 50, a diameter of the lid attachment shaft and so forth. In view of this, both the incline surfaces 55 and 57 of the block-shaped protrusion 43 are sloped in this embodiment so as to approach to each other as these surfaces 55 and 57 separate from the slot forming surface 32 (the second end portion 32b). By virtue of this, even if the position of the contact portion 52a shifts, the contact portion 52a can abut on any portion of either one of the incline surfaces 55 and 57. Thus, when the loading lid 35 is kept in the lock position, the contact portion 52a abuts on the first incline surface 55 so that the loading lid 35 is prevented from being loose. Moreover, when the loading lid 35 is rotated to the open position via the lock release position, the contact portion 52a abuts on the third incline surface 57 so that the loading lid 35 is prevented from being loose.

In sliding the loading lid 35 from the lock position to the lock release position, the torsion spring 42 is also slid together therewith via the lid attachment shaft 38. Since the first arm 52 of the torsion spring 42 elastically engages with the block-shaped protrusion 43, a feeling of resistance is given to the slide operation of the loading lid 35. When the slide operation overcoming the resistance has been performed, the engagement of the first arm 52 and the block-shaped protrusion 43 is released. In virtue of this, the contact portion 52a of the first arm 52 is moved along the first and second incline surfaces 55 and 56 of the block-shaped protrusion 43 in a state that the first arm 52 of the torsion spring 42 is elastically deformed.

Before completing the slide movement of the loading lid 35, the contact portion 52a climbs over the corner 59. After climbing over the corner 59, the contact portion 52a falls along the third incline surface 57 owing to the elastic restoring force of the first arm 52. At this time, a click feeling and a click sound are caused in accordance with the height H1 of the third incline surface 57 and a slope angle thereof relative to the slot forming surface 32 (the second end portion 32b).

In order to surely carry the click feeling and the click sound to a user, it is preferable that the height H1 of the third incline surface 57 is determined as tall as possible on condition that the movement of the contact portion 52a is not disturbed. Moreover, by setting the slope angle of the third incline surface 57 to about 90 degrees, it is possible to much surely carry the click feeling and the click sound to the user. After the loading lid 35 has been slid to the lock release position, the contact portion 52a abuts on an end portion of the third incline surface 57 closer to the slot forming surface 32 (see FIG. 7).

In contrast, when the loading lid 35 is slid from the lock release position to the lock position, a feeling of resistance is similarly given to the slide operation of the loading lid 35. Upon performing the slide operation overcoming the resistance, the contact portion 52a of the first arm 52 is moved along the third and second incline surfaces 57 and 56 of the block-shaped protrusion 43. After climbing over the corner 60, the contact portion 52a falls along the first incline surface 55 owing to the elastic restoring force of the first arm 52. Also at this time, a click feeling and a click sound are caused in accordance with the height H4 of the first incline surface 55 and a slope angle thereof. After the loading lid 35 has been slid to the lock position, the contact portion 52a abuts on an end portion of the first incline surface 55 closer to the slot forming surface 32 (see FIG. 6).

As described above, when the loading lid 35 is kept in the lock position, the contact portion 52a of the first arm 52 abuts on the first incline surface 55 of the block-shaped protrusion 43. In this embodiment, whether or not the contact portion 52a is kept in the abutment position of the first incline surface 55 is detected by the detection switch 44 to detect opening and closing of the loading lid 35. The detection switch 44 is of a push-button type composed of a cylindrical push button 44a and a switch body 44b.

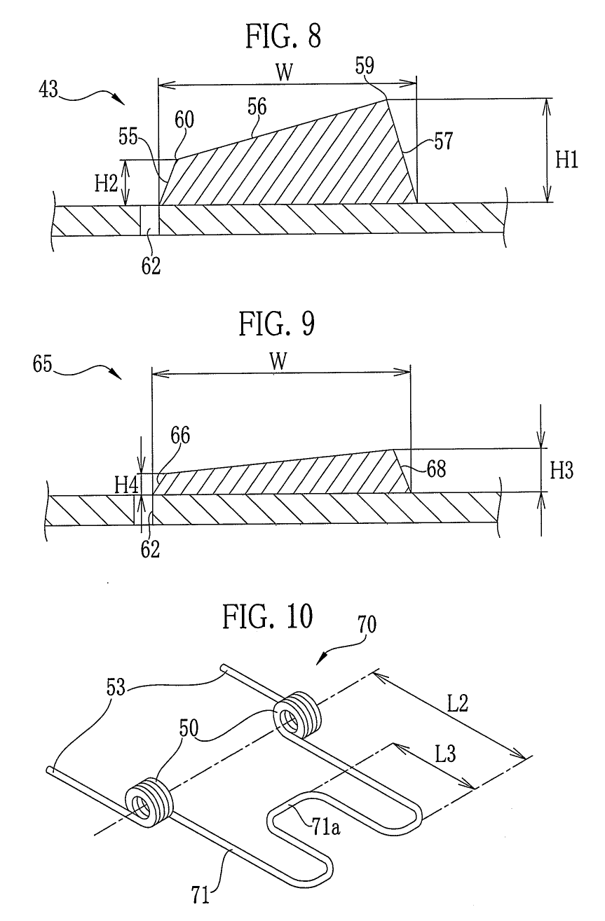

The switch body 44b is disposed in the case 11. The push button 44a projects from a through-hole 62 (see FIG. 8) formed in the slot forming surface 32. The through-hole 62 is formed at an adjacent position of the first incline surface 55. It is sufficient that the through-hole 62 is formed so as to have a size capable of inserting the push button 44a therein. Accordingly, it is possible to reduce the size of the through-hole 62. Influence for an appearance of the container unit 27 is minimized. When the loading lid 35 is kept in the lock position, the contact portion 52a of the first arm 52 presses the push button 44a. In virtue of this, the switch body 44b is turned on (see FIG. 6). When the loading lid 35 is slid to the lock release position, the push button 44a is released from being pressed by the contact portion 52a. In virtue of this, the switch body 44b is turned off (see FIG. 7) . The switch body 44b is connected to a controller (not shown) controlling the respective parts of the camera 10. The controller can detect opening and closing of the loading lid 35 on the basis of a detection signal sent from the switch body 44b.

As described above, in this embodiment, the loading lid 35 is clicked and locked at the lock position by engaging the block-shaped protrusion 43 with the torsion spring 42 fixed to the lid attachment shaft 38. Moreover, by sliding the loading lid 35 to the lock release position, the loading lid 35 is automatically rotated to the open position owing to the elastic restoring force of the torsion spring 42.

The following description relates to a procedure for loading the battery pack 28 and the memory card 29 to the container unit 27 of the electronic camera 10. A user handles the slide operating portion 49 of the loading lid 35 clicked and locked at the lock position to slide the loading lid 35 toward the lock release position. Upon performing the slide operation overcoming the resistance caused at the slide-operation time, the first arm 52 of the torsion spring 42 is elastically deformed and the contact portion 52a thereof is moved along the first and second incline surfaces 55 and 56 of the block-shaped protrusion 43. Further, since the push button 44a is released from being pressed by the contact portion 52a, the detection signal outputted from the detection switch 44 is turned off.

Upon further sliding the loading lid 35, the contact portion 52a climbs over the corner 59. After that, the contact portion 52a falls along the third incline surface 57 owing to the elastic restoring force of the first arm 52. At this time, the click feeling and the click sound are caused so that the user can confirm the disengagement of the loading lid 35. When the loading lid 35 has been slid to the lock release position, the contact portion 52a abuts on the end portion of the third incline surface 57 closer to the slot forming surface 32 (see FIG. 7).

When the loading lid 35 is slid to the lock release position, the engagement claw 40 is disengaged from the engagement frame 41. Upon disengagement of the claw 40 and the frame 41, the loading lid 35 is automatically rotated to the open position owing to the elastic restoring force of the torsion spring 42. And then, the loading lid 35 is retained in the open position. At this time, the contact portion 52a of the first arm 52 abuts on the third incline surface 57 so that the loading lid 35 is prevented from being loose. After rotating the loading lid 35 to the open position, the user loads the battery pack 28 into the battery chamber 33a through the battery slot 34a. Further, the user loads the memory card 29 into the card chamber 33b through the card slot 34a.

After loading the battery pack 28 and the memory card 29, the user rotates the loading lid 35 to the lock release position against the biasing force of the torsion spring 42. Successively, the user slides the loading lid 35 from the lock release position to the lock position. Similarly to the lock release time, the first arm 52 of the torsion spring 42 is elastically deformed and the contact portion 52a thereof is moved along the third and second incline surfaces 57 and 56 of the block-shaped protrusion 43 upon performing the slide operation overcoming the resistance caused at the slide-operation time.

Upon further sliding the loading lid 35, the contact portion 52a climbs over the corner 60. After that, the contact portion 52a falls along the first incline surface 55 owing to the elastic restoring force of the first arm 52. At this time, the click feeling and the click sound are caused so that the user can confirm the engagement of the loading lid 35. Further, since the contact portion 52a presses the push button 44a, the detection signal to be outputted from the detection switch 44 is turned on.

When the loading lid 35 has been slid to the lock position, the engagement claw 40 engages with the engagement frame 41 and the loading lid 35 is retained so as not to be opened. At this time, since the block-shaped protrusion 43 abuts on the contact portion 52a of the torsion spring 42 (the first arm 52) , the torsion spring 42 elastically engages with the block-shaped protrusion 43. In virtue of this, the loading lid 35 is clicked and locked at the lock position.

In this way, the torsion spring 42 is also used for clicking and locking the loading lid 35 so that the loading lid 35 is rotated to the open position after releasing the lock without increasing a number of parts and assembling processes. As a result, it is possible to save a manual operation of the user by which the loading lid 35 is opened to the open position. In addition, it is possible to hold down the production cost of the electronic camera 10.

In the above embodiment, for the purpose of surely carrying the click feeling and the click sound to the user, the height H1 of the third incline surface 57 of the block-shaped protrusion 43 is adapted to be determined as tall as possible on condition that the movement of the contact portion 52a is not disturbed (see FIG. 8) . The present invention, however, is not limited to this. For instance, the click feeling and the click sound of the slide-operation time may be restrained such as a block-shaped protrusion 65 shown in FIG. 9.

Although the block-shaped protrusion 65 is formed such that a longitudinal length thereof is W, which is identical with that of the foregoing block-shaped protrusion 43, heights of the first and third incline surfaces 66 and 68 are lower than those of the block-shaped protrusion 43. Concretely, when the height of the third incline surface 68 is denoted by H3 and the height of the first incline surface 66 is denoted by H4, relationships of H3<H1 and H4<H2 are satisfied. By adjusting the heights of the incline surfaces 66 and 68 so as to satisfy these relationships, it is possible to restrain the click feeling and the click sound. In this instance, by decreasing the slope angles of the incline surfaces 66 and 68 as need arises, it is possible to further restrain the click feeling and the click sound.

In the above embodiment, whether or not the contact portion 52a of the first arm 52 abuts on the first incline surface 55 of the block-shaped protrusion 43 is detected by the detection switch 44 of the push-button type in order to detect opening and closing of the loading lid 35. The present invention; however, is not limited to this. Various detection switches and detection sensors may be used on condition that it is possible to detect whether or not the contact portion 52a abuts on the first incline surface 55.

In the above embodiment, the first arm 52 of the torsion spring 42 is curved in the U-like shape between the coil portions 50. The present invention, however, is not limited to this. The shape of the first arm 52 is not limited on condition that this arm is curved in a convex shape.

In the above embodiment, the contact portion 52a of the first arm 52 of the torsion spring 42 is adapted to be parallel to the lid attachment shaft 38. The present invention, however, is not limited to this. For example, sometimes it is impossible to obtain a sufficient room for the second end portion 32b of the slot forming surface 32 due to downsizing of the electronic camera 10. In this instance, if the length L1 (see FIG. 5) of the first arm 52 of the torsion spring 42 is shortened so as to be disposed within a small space, an amount of the elastic deformation becomes large when the first arm 52 climbs over the block-shaped protrusion 43. As a result, necessary force for the slide operation of the loading lid 35 is likely to be too great . Further, when the slide operation of the loading lid 35 is repeatedly performed, the first arm 52 is likely to be damaged.

In view of this, such as a torsion spring 70 shown in FIG. 10, a contact portion 71a of the first arm 71 may be bent in a concave shape. In this instance, when L2 (<L1) represents a length between the pair of the coil portions 50 and both ends of the contact portion 71a, and L3 represents a length between both ends of the contact portion 71a and a central portion thereof , it is possible to obtain a length of L2+L3 from the coil portion 50 to the central portion of the contact portion 71a coming into contact with the block-shaped protrusion 43. In this way, it is possible to adjust the necessary force for the slide operation of the loading lid 35 even when the area of the second end portion 32b is small. The torsion spring 70 having the above-mentioned shape is easily produced differently from a leaf spring and so forth requiring mold change for its production. Consequently, it is preferable to use the torsion spring from viewpoints of its cost and delivery date. Incidentally, although illustration is abbreviated, the contact portion 71a of the first arm 71 may be curved, instead of being bent in the concave shape.

In the foregoing embodiments, the used torsion spring 42 has the double-torsion-spring structure. The present invention, however, is not limited to this. It is possible to use a torsion spring comprising a single coil portion and first and second arms extending from the coil portion. In this instance, a top portion of the first arm may be bent or curved to form a contact portion.

In the foregoing embodiment, for the purpose of retaining the loading lid 35 so as not to be opened, the loading lid 35 is provided with the engagement claw 40 and the case 11 is provided with the engagement frame 41. The present invention, however, is not limited to this. The engagement members may have various shapes on condition that engagement and disengagement are switched by the slide operation of the loading lid 35.

In the foregoing embodiment, the second arm of the torsion spring 42 abuts on the inner surface 35a of the loading lid 35. The present invention, however, is not limited to this. The second arm 53 may be fixed to the loading lid 35 on condition that the second arm 53 can bias the loading lid 35 in the open direction.

In the foregoing embodiment, the loading lid 35 is rotatably attached to the case 11 via the lid attachment shaft 38 perpendicular to the front (rear) of the case 11. The present invention, however, is not limited to this. The loading lid 35 may be attached to the case via a lid attachment shaft perpendicular to a lateral side of the case 11.

In the foregoing embodiment, the block-shaped protrusion 43 has the first to third incline surfaces 55 to 57 and is formed so as to have a quadrangular section. The present invention, however, is not limited to this. For instance, the block-shaped protrusion 43 may be formed so as to have a triangular section or a polygonal (pentagon or more) section. Meanwhile, the first to third incline surfaces 55 to 57 may be formed so as to have a curved-surface shape instead of the plane-surface shape.

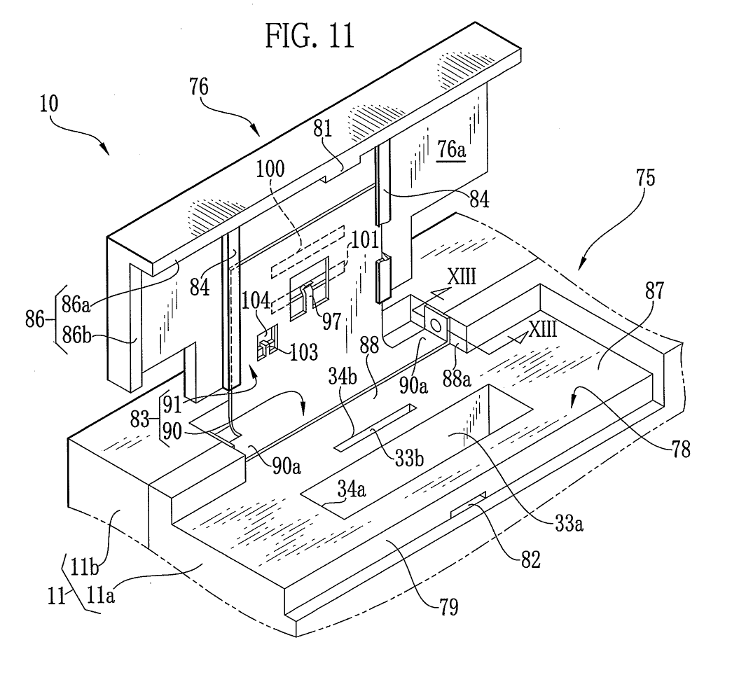

In the foregoing embodiment, the loading lid 35 is rotatable and slidably attached to the shaft support member 39 of the case 11 via the lid attachment shaft 38. The present invention, however, is not limited to this. For instance, such as a retainer unit 75 shown in FIGS. 11 and 12, a loading lid 76 may be rotatably and slidably attached to the case 11 via a plate-like elastic member. The container unit 75 is concretely described below. Incidentally, a component identical with that of the foregoing container unit 27 is denoted by the same reference numeral and description thereof is abbreviated.

The container unit 75 is composed of the battery chamber 33a, the card chamber 33b, the battery slot 34a, the card slot 34b, the loading lid 76, a slot forming surface 78 and a cutout surface 79. Further, the container unit 75 comprises a first engagement claw 81, an engagement hole 82, a leaf spring 83 and a guide rib 84, which constitute the lock device according to the present invention.

A side wall 86 is formed on an inner surface 76a of the loading lid 76. The side wall 86 is composed of a first wall member 86a and a second wall member 86b. The first wall member 86a is disposed on an edge portion of the inner surface 76a located at the front side of the case. The second wall member 86b is disposed on an edge portion of the inner surface 76a located at a lateral side of the case. The first engagement claw 81 is formed on an inner side of the first wall member 86a. Meanwhile, the slide operating portion 49 (see FIG. 12) is formed on an outer surface of the loading lid 76.

The slot forming surface 78 is composed of a slot forming portion 87 in which the battery slot 34a and the card slot 34b are formed, and a spring attachment portion 88 to which the leaf spring 83 is attached. A corner made by the slot forming surface 78 and the front of the case is cut to form the cutout surface 79 perpendicular to the slot forming surface 78. The engagement hole 82 is formed in the cutout surface 79 to engage with the first engagement claw 81.

The leaf spring 83 to be used may be formed from various materials of metallic material, resin material and so forth. The leaf spring 83 is composed of a pivot portion 90 and a lid support portion 91, which are integrally formed. The pivot portion 90 is fixed to the spring attachment portion 88 of the slot forming surface 78. The lid support portion 91 overlaps with the inner surface 76a of the loading lid 76. The pivot portion 90 extends in a perpendicular direction to the lateral side of the case to abut on the spring attachment portion 88 of the slot forming surface 78. Further, each of end portions 90a of the pivot portion 90 is perpendicularly bent to abut on a cutout surface 88a constituting the spring attachment portion 88.

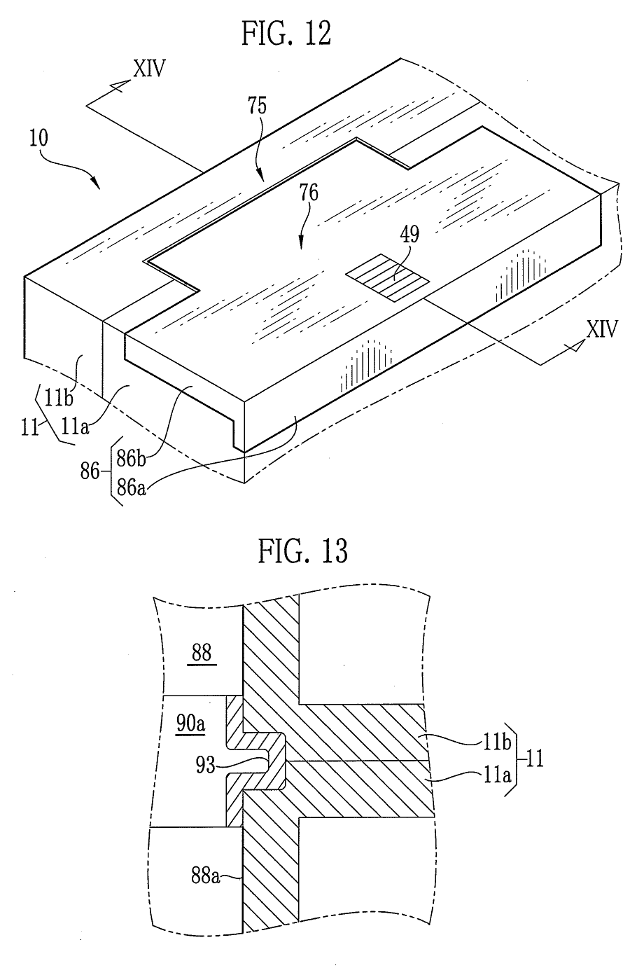

As shown in FIG. 13, the end portion 90a of the pivot portion 90 is provided with an attachment shaft 93 formed by drawing. In this embodiment, the attachment shaft 93 is held between the front cover Ha and the rear cover 11b to attach the leaf spring 83 to the spring attachment portion 88 of the slot forming surface 78. For the purpose of surely attaching the leaf spring 83, the pivot portion 90 thereof may be fixed to the spring attachment portion 88 by means of a screw and so forth.

As to the lid support portion 91 of the leaf spring 83, both sides thereof are supported by the pair of the guide ribs 84 disposed on the inner surface 76a of the loading lid 76 (see FIG. 11). The guide rib 84 is formed so as to have an L-like section. In virtue of this, it is possible to slide the loading lid 76 along the slot forming surface 78. By sliding the loading lid 76, the first engagement claw 81 of the loading lid 76 is engaged with and disengaged from the engagement hole 82 of the case 11.

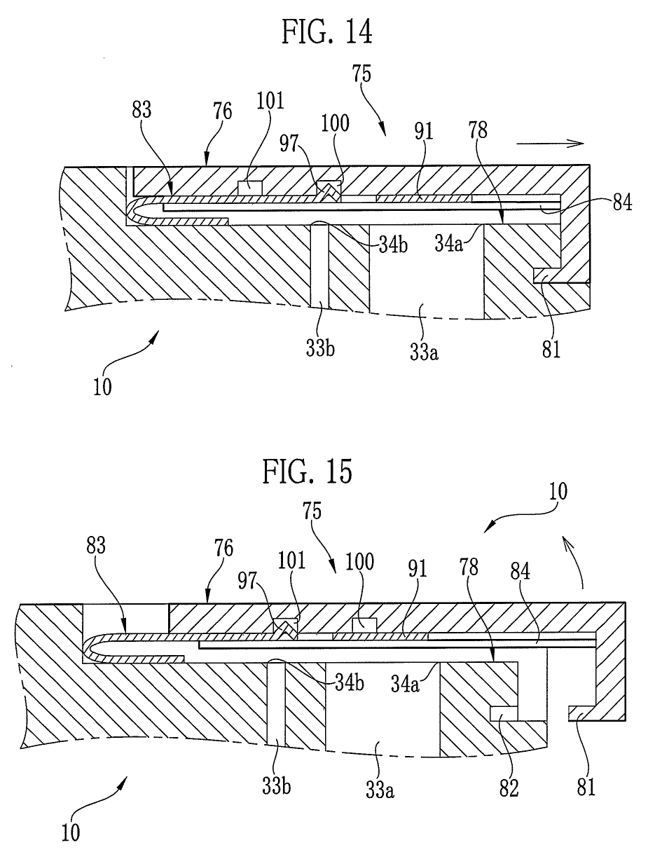

As shown in FIGS. 14 and 15, when the loading lid 76 is kept in the lock position where the loading lid 76 covers the slot forming surface 78 and is retained by the case 11 (see FIG. 14) , the first engagement claw 81 engages with the engagement hole 82. Thus, the loading lid 76 is locked so as not to be opened. At this time, the leaf spring 83 is charged because a portion thereof positioned between the pivot portion 90 and the lid support position 91 is bent in a U-like shape.

Upon sliding the loading lid 76 to a lock release position where the first engagement claw 81 is disengaged from the engagement hole 82 (see FIG. 15) , the loading lid 76 is rotated to the open position owing to the elastic restoring force of the leaf spring 83 bent in the U-like shape. After removing and loading the battery pack 28 and the memory card 29, the loading lid 76 is rotated to the lock release position against the biasing force of the leaf spring 83. Successively, the loading lid 76 is slid to the lock position. By doing so, the loading lid 76 is locked so as not to be opened.

For the purpose of clicking and locking the loading lid 76 at the lock position, the lid support portion 91 of the leaf spring 83 has a second engagement claw 97 integrally formed therewith. The second engagement claw 97 is formed so as to have a triangular section, the top of which protrudes toward the inner surface 76a of the loading lid 76. Meanwhile, a first groove 100 and a second groove 101 are formed in the inner surface 76a of the loading lid 76. The second engagement claw 97 of the leaf spring 83 elastically engages with the grooves 100 and 101. In virtue of these grooves, the loading lid 76 is clicked and locked at the lock position and the lock release position.

The first and second grooves 100 and 101 are formed so as to extend in a perpendicular direction to the lateral side of the case. The first groove 100 is formed at a location where the second engagement claw 97 engages therewith at a time when the loading lid 76 is kept in the lock position. The second groove 101 is formed at a location where the second engagement claw 97 engages therewith at a time when the loading lid 76 is kept in the lock release position. By the way, instead of the first and second grooves 100 and 101, various concave portions of an engagement hole and so forth may be formed on condition that the second engagement claw 97 is capable of engaging therewith.

When the loading lid 76 is slid from the lock position toward the lock release position, a feeling of resistance is given to the slide operation of the loading lid 76 because the second engagement claw 97 elastically engages with the first groove 100. Upon performing the slide operation overcoming the resistance, the second engagement claw 97 is disengaged from the first groove 100 and the loading lid 76 is moved to lock release position. During this movement, the second engagement claw 97 abuts on the inner surface 76a between the grooves 100 and 101 and is elastically deformed.

When the loading lid 76 has been slid to the lock release position, the second engagement claw 97 engages with the second groove 101 and is restored to its original state. At this time, since a click feeling and a click sound are caused, the user can confirm that the slide movement of the loading lid 76 has been completed (see FIG. 15). In the meantime, a retaining claw 103 (see FIG. 11) is formed on the lid support portion 91 of the leaf spring 83. Further, a retaining groove 104 (see FIG. 11) is formed in the inner surface 76a of the loading lid 76. The retaining claw 103 slidably engaged with the retaining groove 104. When the loading lid 76 is slid to the lock release position, the retaining claw 103 abuts on one end of the retaining groove 104 so that the loading lid 76 is prevented from unfastening.

Upon moving the loading lid 76 to the lock release position, the loading lid 76 is rotated to the open position owing to the elastic restoring force of the leaf spring 83. Thus, the battery slot 34a and the card slot 34b are opened.

After loading the battery pack 28 and the memory card 29, the loading lid 76 is rotated to the lock release position. And then, the loading lid 76 is slid toward the lock position. At this time, the feeling of resistance is similarly given to the slide operation of the loading lid 76, and the slide operation overcoming the resistance is performed. By virtue of this, the second engagement claw 97 is disengaged from the second groove 101 and the loading lid 76 is moved toward the lock position. When the loading lid 76 has been slid to the lock position, the second engagement claw 97 engages with the first groove 100, and the click feeling and the click sound are caused. In this way, the loading lid 76 is clicked and locked at the lock position.

As described above, in the container unit 75, the leaf spring 83 is also used for clicking and locking the loading lid 76. Thus, similarly to the foregoing container unit 27, it is possible to rotate the loading lid 76 to the open position after the lock release without increasing a number of parts and assembling processes.

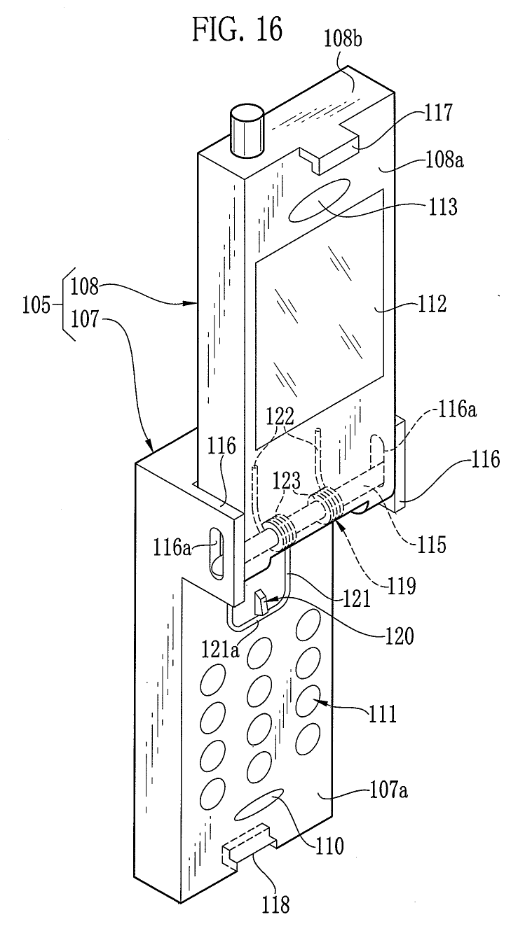

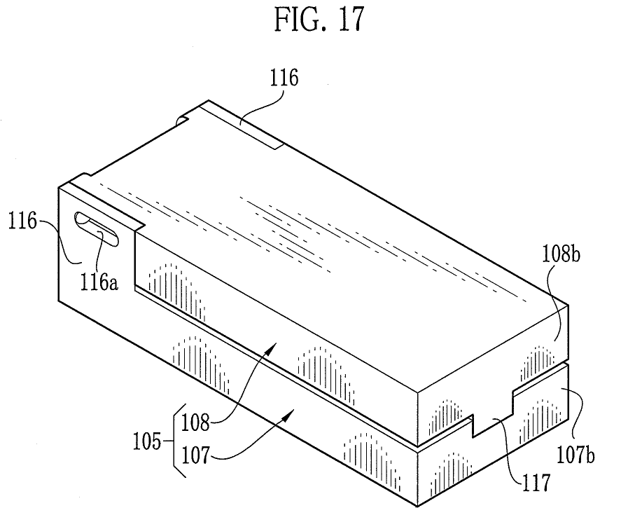

In the above embodiments , the loading lid 35 (76) rotated to the open position is rotatably and slidably supported by the case 11 of the electronic camera 10. The present invention, however, is not limited to this and may be adopted to other instances in that lids openably supported by various cases are rotated. Concretely, the present invention may be applied to opening and closing of a foldable cell-phone (hereinafter, simply called as call-phone) 105 such as shown in FIGS. 16 and 17. The cell-phone 105 is specifically described below.

The cell-phone 105 is composed of a mouthpiece unit 107 and an earpiece unit 108. The mouthpiece unit 107 corresponds to the case of the present invention and the earpiece unit 108 corresponds to the lid thereof. An inner surface 107a of the mouthpiece unit 107 is provided with a microphone 110 and an operating portion 111. An inner surface 108a of the earpiece unit 108 is provided with an LCD monitor 112 and a speaker 113. The cell-phone 105 comprises a hinge shaft 115, shaft support members 116, an engagement claw 117, an engagement hole 118, a torsion spring 119 and a block-shaped protrusion 120, which constitute a lock device having a structure substantially identical with that of the foregoing container unit 27.

The hinge shaft 115 connects the mouthpiece unit 107 and the earpiece unit 118 in a foldable manner. Both ends of the hinge shaft 115 are fitted into elongate holes 116a of the pair of the shaft support members 116 integrally formed with the mouthpiece unit 107. The elongate hole 116a of the shaft support member 116 extends in a longitudinal direction of the mouthpiece unit 107. In virtue of this , the earpiece unit 108 is rotatably and slidably supported by the mouthpiece unit 107.

The engagement claw 117 is disposed at a corner formed by the inner surface 108a of the earpiece unit 108 and a top surface 108b thereof. The engagement hole 118 is located at a corner formed by the inner surface 107a of the mouthpiece unit 107 and a bottom surface 107b thereof (see FIG. 17). The engagement claw 117 and the engagement hole 118 are engaged and disengaged by sliding the earpiece unit 108. In other words, the earpiece unit 108 is slidable between a lock position where the engagement claw 117 engages with the engagement hole 118 (see FIG. 17), and a lock release position where the engagement claw 117 is disengaged from the engagement hole 118.

The torsion spring 119 is composed of a pair of coil portions 123 into which the hinge shaft 115 is inserted, and an arm portion including a first arm 121 and second arms 122. The first arm 121 has a contact portion 121a pressed against the inner surface 107a of the mouthpiece unit 107. The second arm 122 is fixed inside the earpiece unit 108. The torsion spring 119 is elastically deformed between the units 107 and 108 when the earpiece unit 108 is kept in the lock position and in the lock release position. Upon sliding the earpiece unit 108 to the lock release position, the torsion spring 119 biases the earpiece unit 108 in an open direction. Thus, the earpiece unit 108 is retained in an open position where the inner surface 107a of the mouthpiece unit 107 is exposed (see FIG. 16).

The block-shaped protrusion 120 is identical with the foregoing block-shaped protrusion 43 and is disposed on the inner surface 107a of the mouthpiece unit 107. The block-shaped protrusion 120 engages with the contact portion 121a of the first arm 121 of the torsion spring 119 when the earpiece unit 108 is kept in the lock position and in the lock release position. Thus, the earpiece unit 108 is clicked at the lock position and the lock release position.

As described above, in the cell-phone 105, the torsion spring 119 is also used for clicking and locking the earpiece unit 108. In virtue of this, it is possible to rotate the earpiece unit 108 to the open position after the lock release without increasing a number of parts of the cell phone 105 and assembling processes thereof. Incidentally, the foregoing detection switch 44 (see FIGS. 6 and 7) may be disposed at the inner surface 107a of the mouthpiece unit 107 to detect opening and closing of the earpiece unit 108, although an illustration is abbreviated.

### INDUSTRIAL APPLICABILITY

The present invention is preferably applied to devices for opening and closing a lid rotatably and slidably supported by a case.

1. A lid opening and closing mechanism in which a lid rotatably and slidably attached to a case is slid from a lock position, where said lid covers a part of said case and is locked with said case, to a lock release position, where said lid is unlocked from said case, and said lid is further rotated to an open position, where the covered part of said case is exposed, via said lock release position, said lid opening and closing mechanism comprising:
a spring member for biasing said lid moved to said lock release position, toward said open position; and
a click-lock member with which said spring member elastically engages when said lid is kept in said lock position, elastic engagement of said click-lock member and said spring member giving a resistance to a slide operation of said lid, and upon performing the slide operation overcoming the resistance, said elastic engagement being released and said lid being allowed to move to said lock release position.

2. The lid opening and closing mechanism according to claim 1, further comprising:
a shaft slidably supported by said case, said lid being attached to said case via said shaft.

3. The lid opening and closing mechanism according to claim 2, wherein said shaft is slidably fitted into elongate holes formed in said case.

4. The lid opening and closing mechanism according to claim 2, wherein said spring member is a torsion spring having at least one coil portion into which said shaft is inserted, one end linked to said lid, and an arm portion pressed against said part of said case.

5. The lid opening and closing mechanism according to claim 4, wherein said click-lock member is a block-shaped protrusion formed at said part of said case and has a first contact surface on which said arm portion of said torsion spring abuts when said lid is kept in the locked position, a second contact surface on which said arm portion abuts when said lid is kept in the lock release position, and a third contact surface connecting said first contact surface and said second contact surface, and said arm portion of said torsion spring slides on said first, second and third contact surfaces.

6. The lid opening and closing mechanism according to claim 5, wherein said first contact surface and said second contact surface slope so as to reduce an interval thereof in a height direction.

7. The lid opening and closing mechanism according to claim 6, wherein said second contact surface is higher than said first contact surface.

8. The lid opening and closing mechanism according to claim 7, wherein said torsion spring causes a click feeling and a click sound in accordance with a height and an incline angle of the respective first and second contact surfaces when said lid is slid from one of said lock position and said lock release position to the other thereof.

9. The lid opening and closing mechanism according to claim 6, wherein said torsion spring includes a pair of the coil portions into which said shaft is inserted, and said arm portion is formed between the coil portions so as to have a convex shape.

10. The lid opening and closing mechanism according to claim 9, wherein said arm portion of said torsion spring has a concave portion formed by bending the middle thereof, and said convex portion slides on said first, second and third contact surfaces.

11. The lid opening and closing mechanism according to claim 9, further comprising:
a detector for detecting opening and closing of said lid by judging whether or not said arm portion of said torsion spring is kept in a position abutting on said first contact surface of said block-shaped protrusion.

12. The lid opening and closing mechanism according to claim 11, wherein said detector is a push-button-type switch comprising a cylindrical push button and a switch body, and closing of said lid is detected when said push button is pushed into said switch body by said arm portion of said torsion spring.

13. The lid opening and closing mechanism according to claim 1, wherein said spring member is a leaf spring, one side of which is fixed to said case and the other side of which slidably supports said lid, an engagement claw is formed on said other side to abut on said lid, and said leaf spring is bent and charged when said lid is kept in said lock position and said lock release position, said click-lock member being a hollow formed in said lid and said engagement claw of said leaf spring elastically engaging with said hollow.

14. The lid opening and closing mechanism according to claim 13, wherein said engagement claw is formed by bending and projecting a part of said spring member.

15. The lid opening and closing mechanism according to claim 1, wherein a slot connecting to a loading chamber disposed inside said case is formed in said part of said case, said slot being closed when said lid is kept in said lock position and said lock release position, and said slot being exposed when said lid is kept in said open position.

16. The lid opening and closing mechanism according to claim 15, wherein said loading chamber contains a battery for supplying electric power to a body of an electronic camera built in said case, and said lid is opened when said battery is inserted into said loading chamber.

17. The lid opening and closing mechanism according to claim 15, wherein said loading chamber contains a memory card for storing image data taken by a body of an electronic camera built in said case, and said lid is opened when said memory card is inserted into said loading chamber.

18. The lid opening and closing mechanism according to claim 1, wherein said lid is an earpiece unit of a foldable cell-phone and said case constitutes a mouthpiece unit of said cell-phone.
